(19) United States
(12) Patent Application Publication
(10) Pub. No.: US 2014/0064457 A1
(43) Pub. Date: Mar. 6, 2014

(54) X-RAY COLLIMATOR

(71) Applicant: IDI Dental, Inc., Marietta, GA (US)

(72) Inventors: Michael R. Razzano, Marietta, GA (US); Raynold Lee Saar, Marietta, GA (US)

(21) Appl. No.: 14/016,277

(22) Filed: Sep. 3, 2013

Related U.S. Application Data
(60) Provisional application No. 61/695,736, filed on Aug. 31, 2012.

(51) Int. Cl. G21K 1/02

(52) U.S. Cl. CPC G21K 1/02
USPC 378/147

(57) ABSTRACT

Disclosed is a system for attenuating x-rays. The disclosed devise utilizes a copper barrier having a minimum total thickness of at least 0.12 mm. The device can be utilized as part of a collimator and/or as part of a masking wall.

### CROSS REFERENCE TO RELATED APPLICATIONS

This application claims the benefit of U.S. Provisional Application No. 61/695,736, filed Aug. 31, 2012, which is hereby incorporated by reference.

### FIELD OF THE INVENTION

The present invention relates generally to x-ray collimators and x-ray masking devices.

### BACKGROUND

In today's medical profession, there are various ways to capture images of patients, such as images captured for diagnostic purposes. For example, a medical professional such as a dentist can use an x-ray device to capture digital or film based images of the patient's mouth. Collimators and masking devices are used to minimize exposure of both the patient and medical professionals to unnecessary x-rays. These devices typically require using heavy metals, such as lead, which are harmful and difficult to work with. There is a need for improved collimators and masking devices.

### BRIEF DESCRIPTION OF THE DRAWINGS

FIG. 1 is a perspective view of an image capture device with an x-ray collimator tube.

FIG. 2 is a perspective view of a collimator with a portion of the collimator wall cut-away allowing for visualization of the tunnel and cross-section of the collimator wall.

FIG. 3a is a cross sectional view of a first embodiment of the FIG. 2 collimator wall taken along the 3-3.

FIG. 3b is a cross sectional view of a second embodiment of the FIG. 2 collimator wall taken along the 3-3.

FIG. 3c is a cross sectional view of a third embodiment of the FIG. 2 collimator wall taken along the 3-3.

FIG. 3d is a cross sectional view of a fourth embodiment of the FIG. 2 collimator wall taken along the 3-3.

FIG. 4 is a perspective view of a collimator adaptor incorporating an internal mask.

FIG. 5 is a perspective view of an x-ray alignment system incorporating an external mask.

### DESCRIPTION OF THE ILLUSTRATED EMBODIMENTS

For the purpose of promoting an understanding of the disclosure, reference will now be made to certain embodiments thereof and specific language will be used to describe the same. It will nevertheless be understood that no limitation of the scope of this disclosure is thereby intended, such alterations, further modifications and further applications of the principles described herein being contemplated as would normally occur to one skilled in the art to which the disclosure relates. In several FIGs., where there are the same or similar elements, those elements may be designated with the same or similar reference numerals.

In certain aspects the present disclosure provides unique attenuation devices which can attenuate x-rays without adding unnecessary weight or toxic substances in the manner of lead attenuation devices. In accordance with some forms, such attenuation devices are configured to utilize copper to attenuate x-rays. Other attenuating devices may use copper and tin or copper and zinc. A protective layer of nickel may also be used. A portion of x-rays incident upon the disclosed device may be absorbed, a portion may be reflected by the device, and a portion may pass through the device. As used herein, attenuation refers to a clinically significant reduction in x-rays passing through the device.

Accordingly, in one embodiment, the present disclosure provides a device for reducing x-ray radiation emitted from an x-ray source comprising a wall constructed of one or more layers of copper having a minimum total thickness of 0.12 mm. In accordance with certain embodiments, the wall defines a tunnel through which x-rays travel from the generating device to the area of the patient's body positioned at the end of the tunnel. In another embodiment, the wall is oriented substantially perpendicular to the direction of travel of the x-rays emitted from an x-ray source, the wall further includes an opening which allows a portion of the x-rays to pass unobstructed by the wall while another portion of the x-rays are obstructed by the wall. In certain modes the device further includes a layer of tin having a minimum total thickness of 0.12 mm which may provide for further attenuation of x-rays incident upon the device. In one form, the device further comprises a protective coating, non-limiting examples of protective coating materials include: nickel or plastic polymers. In one aspect the device further comprises one or more support layers. In further embodiments the core member may be coated with electroless copper.

In another embodiment, a collimator is composed of a wall comprising copper having a total thickness of at least 0.12 mm. In one form the wall further comprises a layer of tin having a total thickness of at least 0.12 mm. Certain variants further comprise a protective layer. In accordance with certain embodiments the wall may include a core member. In further embodiments the core member may be coated with electroless copper.

In yet another embodiment, an x-ray attenuation device is made by electroplating a wall with a plurality of metallic layers. In one embodiment the wall is first treated with a layer of electroless copper. In another embodiment, the metallic layers are selected from the group consisting of: copper, tin, and nickel. In one form the metallic layers contain at least one layer of copper having a total thickness of at least 0.12 mm. In one aspect the metallic layers contain at least one layer of tin having a total thickness of at least 0.12 mm.

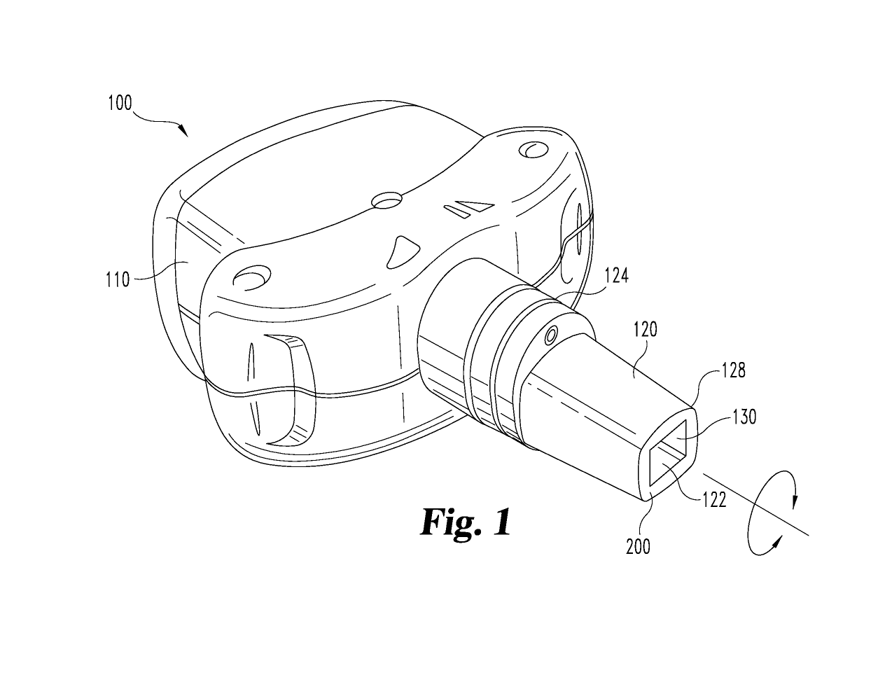

Referring now to FIG. 1, one embodiment of the image capture device of the present disclosure is illustrated and indicated generally at 100. Image capture device 100 is operable to emit x-rays. Image capture device 100 illustrated in FIG. 1 includes x-ray generator 110, and collimator tube 120. Collimator tube 120 may optimally service as a means for limiting the cross-sectional area of x-rays produced by the x-ray generator 110. Alternatively or additionally, collimator tube 120 may also decreases scatter radiation and/or decreases absorbed radiation thereby lowering the x-ray dose emitted out of collimator 120. In one embodiment, collimator tube 120 has a rectangle shape in cross section. Collimator tube 120 can also be square, oval, or round in cross-section shape as a few additional non-limiting examples.

In one embodiment, collimator tube 120 is fixed to x-ray generator 110 and cannot be removed. In another embodiment, collimator tube 120 is detachable from x-ray generator 110 such as by removing one or more screws or other securing needs. Alternatively or additionally, collimator tube 120 can be a collimator tube of one shape that replaces a previously attached collimator tube of a different shape. One non-limiting example includes detaching a round shaped collimator tube and replacing it with a rectangular shaped collimator tube. Collimator tube 120 has a tunnel 122 constructed and arranged to define the emission path of x-rays emitted by x-ray generator 110. Collimator tube 120 attaches to x-ray generator 110 through a first side 124. X-rays are emitted through a second opening 130 on a second side 128 of collimator tube 120. Collimator tube 120 includes wall 200 which defines the boundaries of tunnel 122.

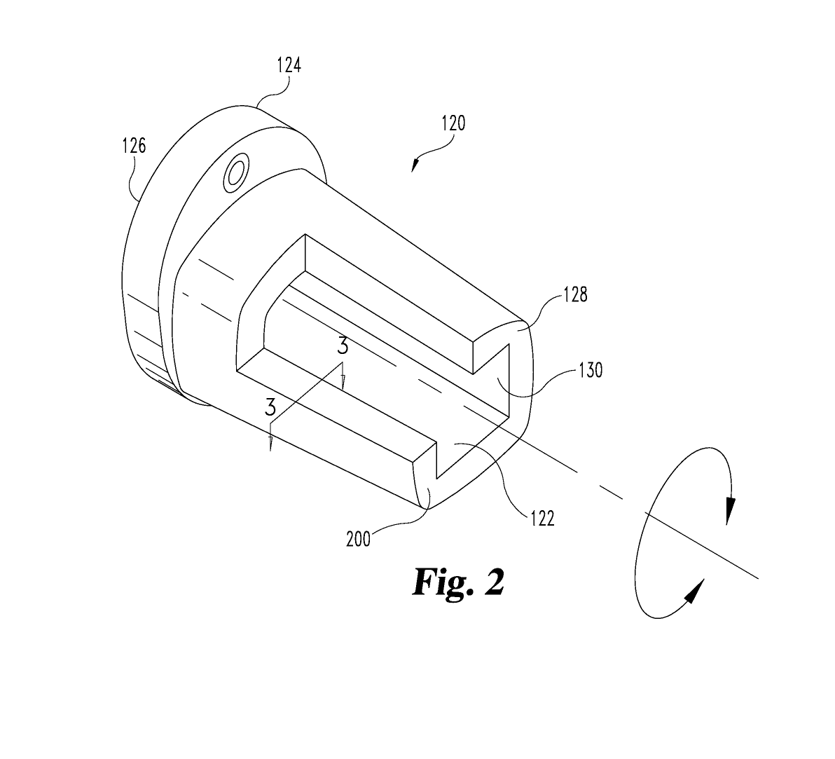

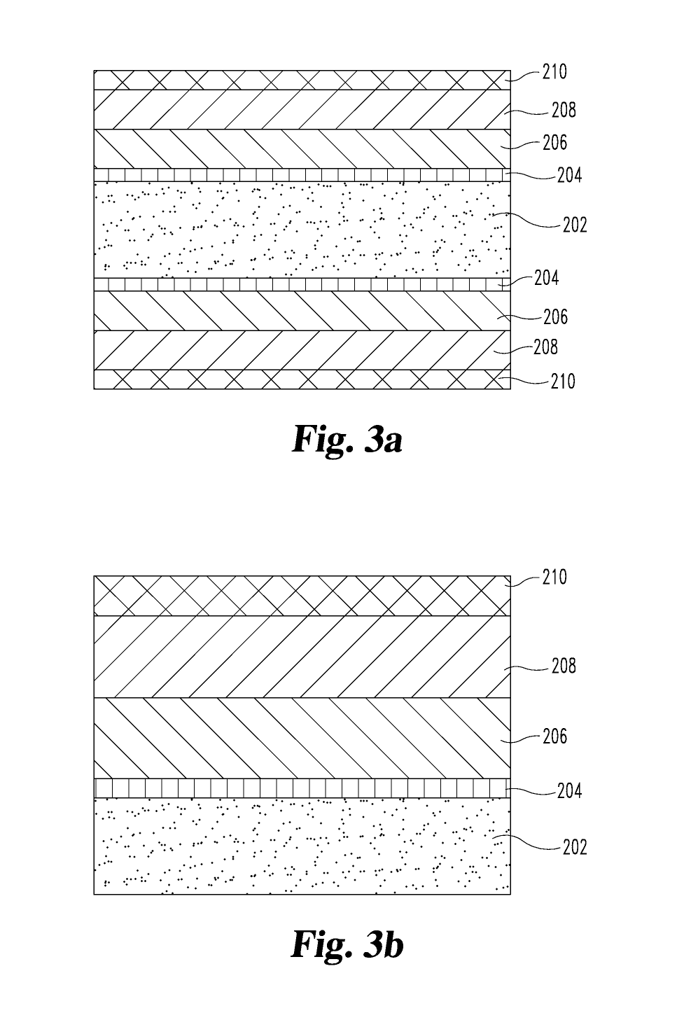

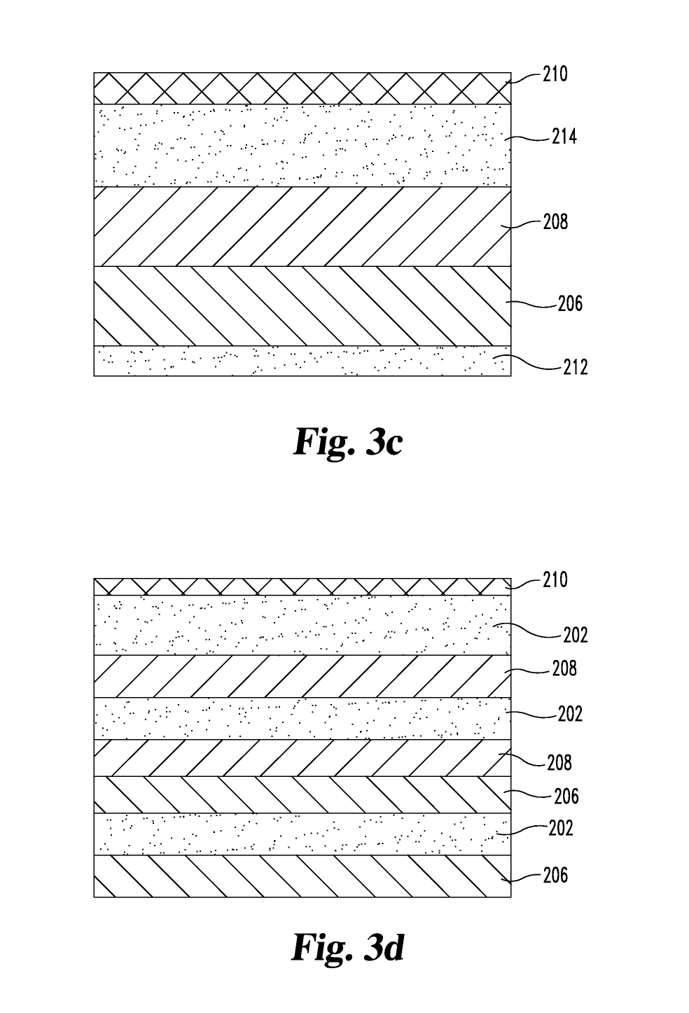

Turning now to FIG. 2, a cut-away view of collimator tube 120 is illustrated. Collimator tube 120 defines first opening 126 on first side 124, which is continuous with a second opening 130 on a second side 128 defining tunnel 122. In one embodiment, collimator tube 120 has a rectangular shape in cross section. Collimator tube 120 can also be square, oval or round in cross-section shape as a few additional non-limiting examples. Various embodiments of the cross-section of wall 200 are illustrated in FIGS. 3a, 3b, 3c and 3d.

The cross-sections illustrated in FIGS. 3a-3d are intended only as non-limiting examples. Any rearrangement of the provided layers is considered within the scope of this disclosure. Also considered within the scope of the present disclosure are the omissions of one or more layers such as: electroless coating layer 204, tin layer 208, protective coating 210, support or core layer 202, core layer 212 and, support layer 214 as described below.

FIG. 3a shows an embodiment wall 200 in which a support or core layer 202 is surrounded by metallic layers comprising an electroless coating 204, a copper layer 206 having a minimal total combined thickness of 0.12 mm, a tin layer 208 having a minimal total combined thickness of 0.12 mm, and a protective coating 210. Non-limiting examples of materials used for the protective coating 210 include, but are not limited to, nickel or plastic polymers. Non-limiting examples of materials used for the electroless coating 204 include, but are not limited to, copper, nickel, silver or gold. Support or core layer 202 can be composed of any suitable material capable supporting the surrounding metallic layers. An example material is a plastic polymer such as acrylonitrile butadiene styrene.

One method of manufacturing the FIG. 3a embodiment is to first apply an electroless coating 204 of copper to support or core layer 202. The layer of electroless copper can be very thin, for example, 0.001 mm. Next, the electroless copper coated support or core layer 202 is electroplated with at least 0.06 mm of copper. This is optionally followed by electroplating with at least 0.06 mm of tin. Either of these states are optionally followed by electroplating with a protective layer of nickel, for example, a 0.006 mm thick layer of nickel. In the event that support or core layer 202 includes a conductive material on its outer layer, the layer of electroless copper may optionally be omitted. Because support or core layer 202 is coated on both sides, the 0.06 mm layers of copper and tin provide a total effective material thickness of 0.12 mm.

It should be understood that this disclosure is not limited to electroplated copper and tin. Other methods of metal deposition may be used as desired including other chemical deposition methods or physical deposition methods as currently know or later developed. Instead of depositing the copper or tin on support or core layer 202, metal foils may be used instead.

Referring now to FIG. 3b, FIG. 3b illustrates an alternative embodiment of wall 200 comprising a support or core layer 202, an electroless coating 204, a copper layer 206, a tin layer 208, and a protective coating 210. Non-limiting examples of materials suitable for the protective coating 210 include, but are not limited to, nickel or plastic polymers. Non-limiting examples of materials suitable for the electroless coating 204 include, but are not limited to, copper, nickel, silver or gold. A non-limiting example of the support or core layer 202 includes any suitable materials, for example, acrylonitrile butadiene styrene.

Turning now to FIG. 3c, FIG. 3c is yet another embodiment of wall 200. FIG. 3c includes an innermost core layer 212 distinct from support layer 214. In such an embodiment, core layer 212 provides the base for addition of metallic layers through, for example, adding foil layers or electrodeposition. Support layer 214 provides structural support. Additionally, FIG. 3c includes, copper layer 206, tin layer 208 and protective coating 210. Non-limiting examples of materials suitable for protective coating 210 include, but are not limited to, nickel or plastic polymers. Support layer 214 may be composed of any suitable materials, for example acrylonitrile butadiene styrene. Core layer 212 may be composed of any suitable material, for example, acrylonitrile butadiene styrene. Core layer 212 may be composed of any suitable material for example, a conductive metal.

Turning now to FIG. 3d and yet another embodiment of the present invention. FIG. 3d contains a plurality of support or core layers 202 as well as a plurality of copper layer 206, a plurality of tin layers 208, and protective coating 210. Suitable materials for protective coating 210 include, but are not limited to, nickel or plastic polymers. Suitable materials for the support or core layer 206 include, for example, acrylonitrile butadiene styrene or any suitable materials as seen by one having ordinary skill in the art. The minimal total thickness of the sum of copper layers 206 equals at least 0.12 mm. The minimum sum total thickness of optional tin layers 208 also equals at least 0.12 mm.

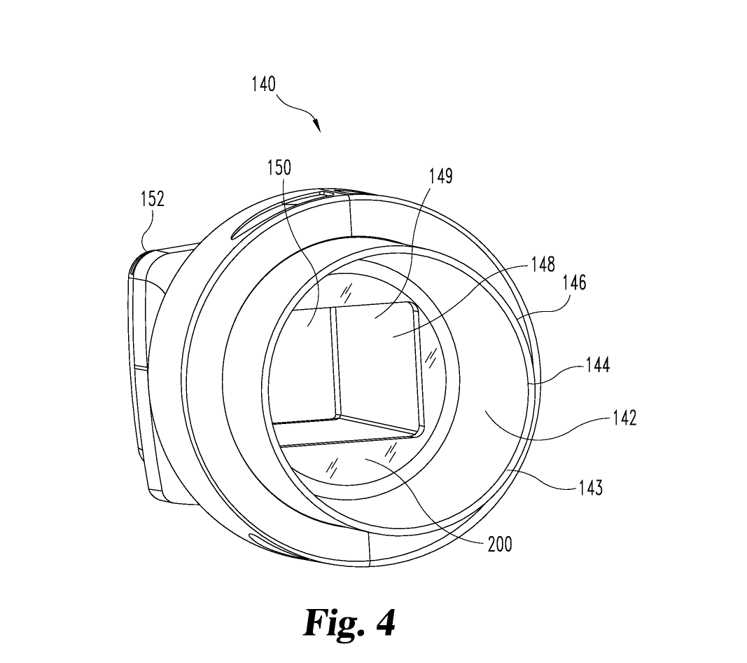

Turning now to FIG. 4, FIG. 4 illustrates a masked collimator 140. Masked collimator tube 140 includes a first opening 144 on a first side 146 continuous with a second opening 150 on a second side 152. The masked collimator 140 includes a first collimating tube 142 of a first shape and a second collimating tube 148 of a second shape. Wall 200 is substantially perpendicular to the direction of travel of x-rays down masked collimator 140 and defines the transition from the first collimating tube 142 to the second collimating tube 148. Wall 200 may be composed of the materials disclosed above such that a cross-section of wall 200 may be illustrated by FIGS. 3a-3d.

Wall 200 is positioned so as to attenuate x-rays travelling through the first collimating tube 142 by masking the x-ray field emitted through the second collimating tube, thereby reducing harmful exposure to unneeded x-rays to the patient. In one embodiment, first collimating tube 142 has a round shape in cross section, while second collimating tube 148 has a rectangular cross section. First collimating tube 142 and second collimating tube 148 can also be square, oval or round in cross-section shape as a few additional non-limiting examples. It is also envisioned that first collimating tube 142 and second collimating tube 148 could have substantially the same shape, with the cross-sectional area of second collimating tube 148 being less than the cross-sectional area of the first collimating tube 142 such that wall 200 serves to mask an x-ray field of substantially the same shape to a reduced cross-sectional area.

First collimating tube wall 143 and/or second collimating tube wall 149 may also optionally comprise a layer of copper having a minimal total thickness of 0.12 mm. In certain embodiments, masked collimator 140 as a whole unit is interchangeable whereby a practitioner desiring a specific x-ray field would attach an appropriate masked collimator 140 to image capture device 100. In alternative embodiments, wall 200 of masked collimator 140 itself may be interchangeable allowing a practitioner to modify the x-ray field by changing only the masking wall 200.

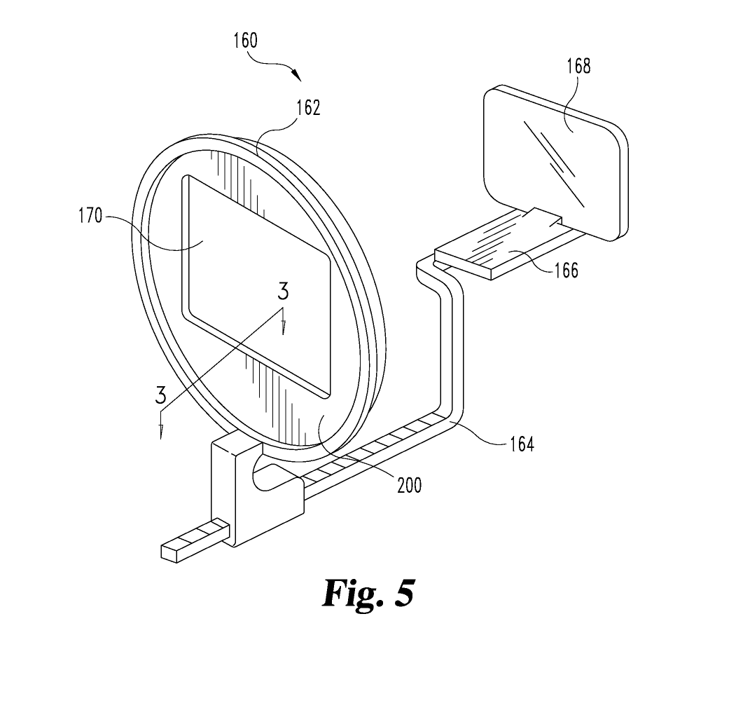

Turning now to FIG. 5, FIG. 5 illustrates an x-ray alignment system 160 containing: alignment ring 162, indicator arm 164, bite block 166 and film or sensor 168. The specific embodiment illustrated is for illustrative purposes only and is intending to be non-limiting. In use, film or sensor 168 and bite block 166 are inserted into a patient's oral cavity wherein the patient bites down on bite block 166 allowing the physician to position film or sensor 168. Alignment ring 162 aids the practitioner to aim x-rays emitting from a collimating tube attached toward film or sensor 168. Such a device is useful, to reduce size of the x-ray field directed at the patient.

When taking an intraoral x-ray, practitioners may use an x-ray field larger than film sensor 168 to avoid cone-cutting which occurs when at least a portion of the film or sensor is positioned outside of the emitted x-ray field. X-ray alignment system 160 allows a practitioner to orient the emitted x-ray field substantially toward film or sensor 168. X-ray alignment system 160 further reduces a patient's exposure to an enlarged x-ray field by incorporating wall 200 within alignment ring 162. Wall 200 comprises at least a layer of copper with a minimum total thickness of at least 0.12 mm according to the present disclosure and functions to mask and align x-rays with film or sensor 168.

In use, a first portion of x-rays emitted toward at alignment ring 162 are incident on wall 200 which substantially attenuates a first portion of the emitted x-rays. A second portion of the emitted x-rays aimed in the direction of alignment ring 162 pass through opening 170 which is defined by wall 200 and is aligned with film or sensor 168. It is envisioned that opening 170 may be provided in a shape that substantially matches film or sensor 160 to minimize patient x-ray exposure.

While at least one embodiment has been illustrated and described in detail in the drawings and foregoing description, the same is to be considered as illustrative and not restrictive in character, it being understood that the preferred embodiment has been shown and described and that all changes, equivalents, and modifications that come within the spirit of the inventions defined by following claims are desired to be protected. It will be evident from the specification that aspects or features discussed in one context or embodiment will be applicable in other contexts or embodiments.

1. A device for reducing x-ray radiation emitted from an x-ray source, the device comprising:
a wall, the wall constructed and arranged to attenuate x-rays, the wall comprising one or more layers of copper having a minimum total thickness of 0.12 mm.

2. The device of claim 1, wherein the wall defines a tunnel, the tunnel having a first opening on a first side constructed and arranged for attachment to the x-ray source, the tunnel also having a second opening on a second side constructed and arranged to emit x-rays from the x-ray source, the tunnel being continuous between the first and the second opening.

3. The device of claim 1, wherein the wall defines an opening and wherein the wall is constructed and arranged to be oriented substantially perpendicular to the direction of travel of the x-rays emitted from an x-ray source, such that a portion of the emitted x-rays are incident to the wall and another portion pass through the opening.

4. The device of claim 1, further comprising:
an x-ray generating device comprising the x-ray source, wherein the x-ray generating device is attached to the wall,

5. The device of claim 1, wherein the wall further comprises one or more layers of tin having a minimum total thickness of 0.12 mm.

6. The device of claim 1, wherein the wall further comprises a protective coating.

7. The device of claim 6, wherein the protective coating is selected from the group consisting of nickel and a plastic polymer.

8. The device of claim 1, wherein the wall further comprises one or more support layers.

9. The device of claim 8, wherein the support layers comprise a plastic polymer coated with a layer of electrolessly deposited metal.

10. A collimator comprising:
a wall defining a tunnel, the tunnel having a first opening on a first side adapted for attachment to an x-ray generating device, the tunnel also having a second opening on a second side adapted for emission of x-rays, wherein the wall comprises: one or more layers of copper having a total thickness of at least 0.12 mm.

11. The collimator of claim 10, wherein the wall further comprises one or more layers of tin having a total thickness of at least 0.12 mm.

12. The collimator of claim 10, wherein the wall further comprises a protective layer.

13. The collimator of claim 12, wherein the protective layer is comprised of nickel.

14. The collimator of claim 10, wherein the wall further comprises a core member.

15. The collimator of claim 14, wherein the core member comprises acrylonitrile butadiene styrene coated with electroless copper.

16. An x-ray attenuation device made by electroplating a wall with a plurality of metallic layers.

17. The device of claim 16, wherein the wall is treated with electroless copper.

18. The device of claim 16, wherein the metallic layers are comprised of metals selected from the group consisting of copper, tin, and nickel.

19. The device of claim 16, wherein the metallic layers comprise at least one layer of copper having a total thickness of at least 0.12 mm.

20. The device of claim 19, wherein the metallic layers comprise at least one layer of tin having a total thickness of at least 0.12 mm.
